(19) United States
(12) Patent Application Publication
(10) Pub. No.: US 2019/0106909 A1
(43) Pub. Date: Apr. 11, 2019

(54) LOCKING BARN DOOR LATCH

(71) Applicant: NW Artisan Hardware, Inc., Kaysville, UT (US)

(72) Inventor: Daniel Wright, Kaysville, UT (US)

(21) Appl. No.: 16/155,783

(22) Filed: Oct. 9, 2018

Related U.S. Application Data
(60) Provisional application No. 62/569,915, filed on Oct. 9, 2017.

(51) Int. Cl. E05B 65/08; E05C 17/48

(52) U.S. Cl. CPC E05B 65/0864; E05C 3/16; E05C 17/48

(57) ABSTRACT

Some embodiments may also include a locking mechanism for a barn door, the locking system comprising: a locking mechanism body; a lock chamber configured to slide into the locking mechanism body in a locked configuration, and configured to slide out of the locking mechanism body in a first direction in an unlocked configuration; and a locking pin coupled with the lock chamber, the locking pin configured to slide outward in a second direction opposite the first direction in the locked configuration, and configured to slide inward in the unlocked configuration.

### SUMMARY

Some embodiments of the invention include a locking mechanism for a sliding barn door. The locking mechanism, for example, may include a lock mechanism. The locking mechanism may include a base configured to couple with a sliding barn door; an external handle; a connecting rod having a proximal end and a distal end, the proximal end of the connecting rod coupled with the external handle; a latch mechanism coupled with the connecting rod; and a locking mechanism disposed within the external handle. The locking mechanism may be configured to lock the external handle from rotating relative to the base such that when the locking mechanism is in a locked configuration the external handle and the rod do not rotate relative to the base, and when the locking mechanism is in an unlocked configuration the external handle, rod, and locking mechanism rotate relative to the base.

In some embodiments, the latch mechanism may be rotatably coupled with the connecting rod such that the latch mechanism rotates with the connecting rod when the connecting rod is rotated in one angular direction relative to the base, and the latch mechanism is capable of being rotated relative to the connecting rod and the base in the same angular direction.

In some embodiments, the locking mechanism may include a spring disposed between the connecting rod and the latch mechanism, wherein the spring biases the latch mechanism relative to the connecting rod.

In some embodiments, the locking mechanism may include a spring disposed between the external handle and the base, wherein the spring biases the external handle relative to the base.

In some embodiments, the latch mechanism comprises a latch body having an aperture and the connecting rod is disposed within the aperture.

In some embodiments, the connecting rod has a rectangular cross-section and the aperture has a rectangular cross-section.

In some embodiments, the latch mechanism comprises a latch head wherein at least a portion of the latch head has a hook shape.

In some embodiments, the latch head is designed and configured to engage with a keeper in the locked configuration and disengaged from the keeper in an unlocked configuration.

In some embodiments, the latch head extends substantially horizontally relative to the connecting rod.

In some embodiments, the latch head extends substantially horizontally in a direction In some embodiments, the latch mechanism comprises an internal handle.

In some embodiments, the latch mechanism is coupled with an internal handle.

In some embodiments, the latch mechanism comprises an aperture though which the connecting rod extends, a latch head, and an internal handle.

In some embodiments, the latch mechanism comprises a side angled surface that has an angle φ measured from the vertical when the lock mechanism is in the locked configuration, the angle φ being between 5° and 35°.

In some embodiments, the latch mechanism comprises a front angled surface that has an angle θ measured from the vertical when the lock mechanism is in the locked configuration, the angle θ being between 5° and 35°.

In some embodiments, the locking mechanism may include a keeper. In some embodiments, the latching mechanism may be configured to engage with the keeper in the locked configuration and disengage with the keeper when transitioning from the locked configuration to the unlocked configuration.

Some embodiments may also include a locking mechanism for a barn door, the locking system comprising: a locking mechanism body; a lock chamber configured to slide into the locking mechanism body in a locked configuration, and configured to slide out of the locking mechanism body in a first direction in an unlocked configuration; and a locking pin coupled with the lock chamber, the locking pin configured to slide outward in a second direction opposite the first direction in the locked configuration, and configured to slide inward in the unlocked configuration.

In some embodiments, the locking mechanism body comprises a cylindrical portion with a hollow center and the lock chamber has a cylindrical shape that slides into and out of the hollow center.

In some embodiments, the lock chamber comprises a key lock.

In some embodiments the locking mechanism body comprises a base configured to couple with a barn door.

In some embodiments, the locking mechanism may include a pin locking mechanism having a pin channel, the pin locking mechanism configured to couple with a door frame.

In some embodiments, the pin channel may be sized and configured to receive the locking pin.

In some embodiments, the pin locking mechanism comprises a slide mechanism configured to slide vertically.

In some embodiments, the slide mechanism covers the pin channel when the slide mechanism is in a first position and the slide mechanism uncovers the pin channel when the slide mechanism is in a second position.

In some embodiments, the pin locking mechanism restricts motion of a barn door coupled with the locking mechanism body when the locking pin is disposed within the pin channel and the slide mechanism is in the first position.

In some embodiments, the locking mechanism may include a spring configured to actuate the lock chamber from the locked position to the unlocked position.

### BRIEF DESCRIPTION OF THE FIGURES

These and other features, aspects, and advantages of the present disclosure are better understood when the following Detailed Description is read with reference to the accompanying drawings.

FIG. 1 illustrates a latch mechanism engaged with a keeper in a locked configuration according to some embodiments.

FIG. 2 illustrates a latch mechanism with a lock slider according to some embodiments.

FIG. 3 illustrates a illustrates a lock mechanism according to some embodiments.

FIG. 4 illustrates a latch mechanism engaged with a keeper and a lock slider in the locked configuration according to some embodiments.

FIG. 5 illustrates a latch mechanism with a lock slider according to some embodiments.

FIG. 6 illustrates a locking mechanism with a lock slider according to some embodiments.

FIG. 7 is a drawing of a latch head according to some embodiments.

FIG. 8A is a top view of the internal handle and the latch head of a latch mechanism according to some embodiments.

FIG. 8B is a side view of the internal handle and the latch head of a latch mechanism according to some embodiments.

FIG. 8C is a front view of the internal handle and the latch head of a latch mechanism according to some embodiments.

FIG. 9A is a top view of the internal handle and the latch head of a latch mechanism according to some embodiments.

FIG. 9B is a side view of the internal handle and the latch head of a latch mechanism according to some embodiments.

FIG. 9C is a front view of the internal handle and the latch head of a latch mechanism according to some embodiments.

FIG. 10A is a top view of a latch mechanism engaged with a keeper and a lock slider in the unlocked configuration.

FIG. 10B is a side view of a latch mechanism engaged with a keeper and a lock slider in the unlocked configuration.

FIG. 10C is an end view of a latch mechanism engaged with a keeper and a lock slider in the unlocked configuration.

FIG. 11. illustrates a locking mechanism with a external handle according to some embodiments.

FIG. 12 illustrates a locking mechanism without a external handle according to some embodiments.

FIG. 13 illustrates a locking door external handle in the unlocked position according to some embodiments.

FIG. 14 illustrates a locking door external handle in the locked position according to some embodiments.

FIG. 15 illustrates a pin locking mechanism according to some embodiments.

FIG. 16 illustrates a pin locking mechanism engaged with a locking pin according to some embodiments.

FIG. 17 illustrates a pin locking mechanism engaged with a locking pin according to some embodiments.

FIG. 18 illustrates a pin locking mechanism engaged with a locking pin according to some embodiments.

### DETAILED DESCRIPTION

Systems and methods are disclosed for a locking barn door latch. In some embodiments, a locking barn door latch may automatically lock when the barn door is closed by sliding the barn door horizontally along a track. A user on the inside or outside of the barn door may open the door by turning a handle, which releases the barn door latch from locking with a looking mechanism. In some embodiments, a user located on the inside of the barn door may engage a lock that restricts the motion of an external handle. The lock may be engaged, for example, by sliding a lock slider from an unlocked position to a locked position. In the locked position, for example, the lock slider may be positioned above the latch restricting the latch from disengaging from the locking mechanism. In some embodiments, the barn door latch may couple with whether the barn door is slide along a track toward the locking mechanism and/or if the barn door swings inwardly from the track toward the locking mechanism

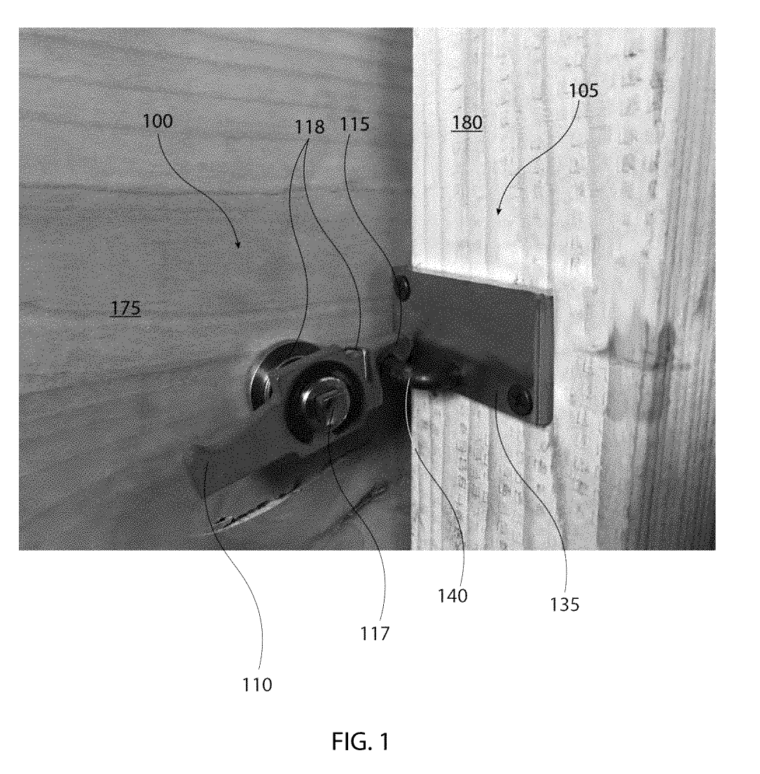

FIG. 1 illustrates a latch mechanism 100 attached with an interior surface of a barn door 175 in a locked configuration with a lock mechanism 105 attached with a doorjamb 180 according to some embodiments.

In some embodiments, the barn door 175 may slide horizontally along a track that couples with barn door 175 with the wall. For example, the track may be mounted about the door opening and the top portion of the barn door 175 may be coupled with the track using wheels, rollers, bearings, etc. In some embodiments, the barn door 175 may also swing along a pivot along the track. For example, when the barn door 175 includes rollers that run on a track coupled with the wall above the door opening. The barn door 175 may swing from a pivot point corresponding with the track. In some embodiments, the barn door 175 may both slide horizontally along the track and/or swing outwardly and inwardly relative to a pivot point relative to the track. The latch mechanism 100 may engage with and/or lock with the lock mechanism 105 regardless of the closing motion: sliding along the track or swinging relative to the track.

In some embodiments, the latch mechanism 100 includes an internal handle 110 and a latch head 115 coupled to the interior of the barn door 175. The latch mechanism 100 includes a pivot axis 117 about with the internal handle 110 and/or the latch head 115 rotate. In some embodiments, an external handle may be coupled with the pivot axis on the exterior of the barn door. When the external handle is rotated, the external handle may rotate an axle that extends through the barn door 175 through the pivot axis 117 and may rotate the internal handle 110 and/or the latch head 115. When the internal handle 110 and/or the latch head 115 is rotated, the internal handle 110 and/or the latch head 115 may rotate an axle that extends through the barn door 175 through the pivot axis 117 and may rotate the external handle.

The latch head 115 may have a portion that has a hook shape (or an inverted U shape). The hook shape may be shaped to include a gap that may be configured to engage with keeper 140 of the lock mechanism 105. For example, the hook shape may have a gap that is sized to be slightly larger than the diameter of the keeper 140.

A spring 118 may bias the latch mechanism 100, for example, such that the latch head 115 and the internal handle 110 are roughly horizontal and/or perpendicular to the doorjamb 180 in a steady state position. When the latch mechanism 100 is rotated away from the steady state position and released, the spring 118 may rotate the latch head 115 and the internal handle 110 into the steady state position. The spring 118 may include a torsion spring.

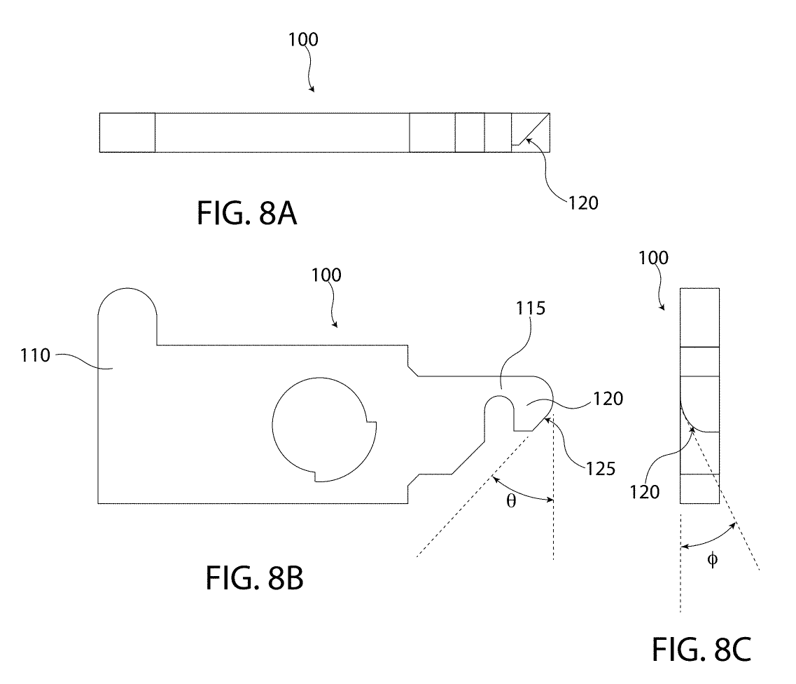

In some embodiments, the latch head 115 may include a front angled surface 125 at the tip, head, or end of the latch head 115. The front angled surface 125, for example, may be angled an angle θ from a vertical reference line when the latch head 115 is not rotated or in the zero-bias position as shown in FIG. 8B. The angle θ, for example, may be an angle from about 10° to 60°. The angle θ, as another example, may be an angle from about 30° to 50°.

In some embodiments, the latch head 115 may include a side angled surface 120. The side angled surface 120, for example, may be angled an angle φ from a vertical reference or from a flat surface of the latch head 115 when the latch head 115 is not rotated or in the zero-bias position as shown in FIG. 8C. The angle φ, for example, may be an angle from about 5° to 35°. The angle φ, as another example, may be an angle from about 15° to 30°.

In some embodiments, the latch mechanism 100 may comprise a metal such as, for example, steel, stainless steel, aluminum, or any alloy thereof, etc. In some embodiments, the latch mechanism 100 may comprise a plastic or composite material.

In some embodiments, the lock mechanism 105 may include a base plate 165. The base plate 165 may comprise a rectangular (or any other shape) shaped member that can be attached to the doorjamb 180. A keeper 140 may be coupled with the base plate 165. The keeper 140 may have a U-shape that extends from the base plate 165.

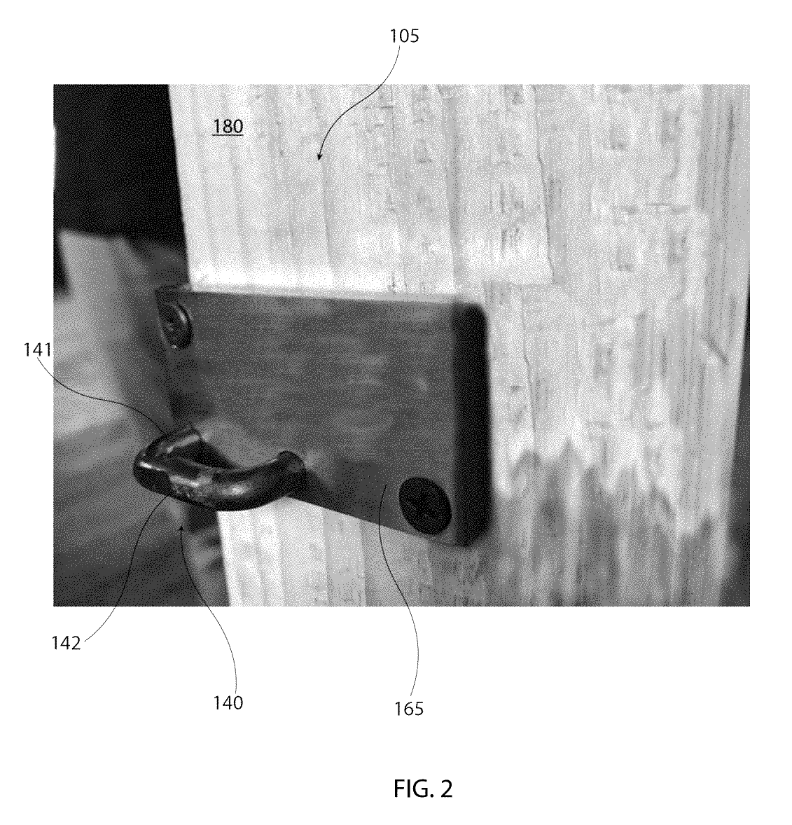

FIG. 2 illustrates a latch mechanism 100 in an unlocked configuration according to some embodiments. The latch mechanism 100 is disengaged from the keeper 140.

In some embodiments, when the barn door 175 slides close to the doorjamb 180 (e.g., by sliding horizontally along a track coupled with a portion of the barn door 175), the latch mechanism 100 may engage with the lock mechanism. For example, the latch head 115 may engage with the keeper 140. For example, as the barn door 175 slides horizontally relative to the doorjamb 180, the front angled surface 125 may make contact with the middle portion of the keeper 142 causing the latch mechanism 100 to rotate upward about the pivot axis 117. As the latch head 115 continues to move horizontally after being rotated about the pivot axis 117, the void in the latch head 115 may be positioned relative to the keeper 140. The spring 118, for example, may rotate the latch head 115 downward causing the latch head 115 to engage with the keeper 140, which may also stop the barn door's momentum as it slides across the track.

In some embodiments, when the barn door 175 swings close to the doorjamb 180 (e.g., by swinging relative to a track coupled with the top of the barn door), the latch mechanism 100 may engage with the lock mechanism. For example, the latch head 115 may engage with the keeper 140. For example, as the barn door 175 swings relative to the doorjamb 180, the front angled surface 125 may make contact with the front portion of the keeper 141 causing the latch mechanism 100 to rotate upward about the pivot axis 117. As the latch head 115 continues to move toward the keeper 140 after being rotated about the pivot axis 117, the void in the latch head 115 may be positioned relative to the keeper 140. The spring 118, for example, may rotate the latch head 115 downward causing the latch head 115 to engage with the keeper 140, which may also stop the barn door's momentum as it slides across the track.

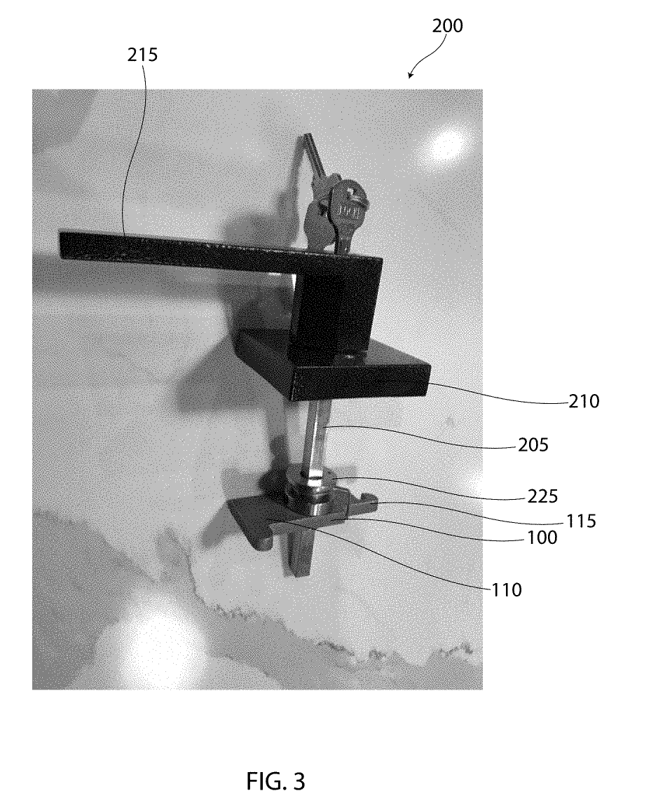

FIG. 3 illustrates a lock mechanism 200 according to some embodiments. The lock mechanism 200 may include a base 210 that may be coupled with a barn door. The lock mechanism 200 may include an external handle 215 that can rotate relative to the base 210.

The external handle 215 may be coupled with the latch mechanism 100 via a connecting rod 205. The external handle 215, for example, may be rotated relative to the base by a user causing the connecting rod 205 and/or the latch mechanism 100 to also rotate. In some embodiments, the connecting rod 205 may have a rectangular (e.g., square) cross-section. In some embodiments, the latch mechanism 100 may have an aperture 230 that has a rectangular cross section through which the connecting rod 205 is disposed.

In some embodiments, the external handle 215 and the latch head 115 of the latch mechanism 100 may extend from the connecting rod 205 in substantially opposite directions and/or may be horizontal relative to one another.

In some embodiments, a user may rotate the external handle 215 (in this example, clockwise although counter clockwise is also possible). As the external handle 215 is rotated, the connecting rod 205 and/or the latch mechanism 100 also rotate. A rotation, for example, may allow a user to engage and/or disengage the latch head 115 of the latch mechanism 100 with a keeper by rotating the external handle 215.

In some embodiments, the latch mechanism 100 may also rotate independently of relative to the connecting rod 205 and/or the external handle 215. In some embodiments, the latch mechanism 100 may be coupled with the connecting rod 205 via an attachment mechanism 225 that is affixed to the connecting rod 205. The latch mechanism 100 may be rotatably coupled with the attachment mechanism 225. In some embodiments, a spring (e.g., a torsion spring) may be disposed between the attachment mechanism 225 and the latch mechanism such as, for example, to bias the latch mechanism 100 into a substantially horizontal position. In some embodiments, when the latch mechanism 100 is engaged with the keeper 140, a user may be able to rotate the latch mechanism 100 relative to the keeper 140 but without rotating the attachment mechanism 225, the connecting rod 205, and/or the external handle 215 to release the latch mechanism 100 from being engaged with the keeper 140.

The lock mechanism 200 may include a lock (e.g., a key lock or tab lock) that may be engaged to lock the external handle 215 and/or the connecting rod 205 from rotating relative to the base 210 and/or disengaged to allow the external handle 215 and/or the connecting rod 205 to rotate relative to the base 210.

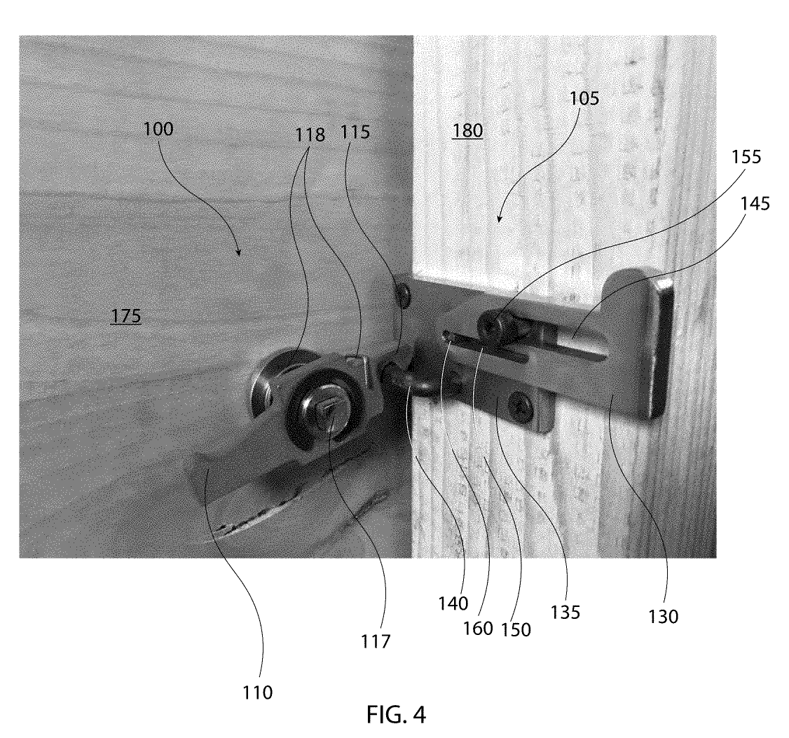

FIG. 4 illustrates a latch mechanism 100 attached with an interior of a barn door 175 in a locked configuration with a lock mechanism 105 attached with a doorjamb 180 according to some embodiments.

In some embodiments, the barn door 175 may slide horizontally along a track that couples with barn door 175 with the wall. For example, the track may be mounted about the door opening and the top portion of the barn door 175 may be coupled with the track using wheels, rollers, bearings, etc. In some embodiments, the barn door 175 may also swing along a pivot along the track. For example, when the barn door 175 includes rollers that run on a track coupled with the wall above the door opening. The barn door 175 may swing from a pivot point corresponding with the track. In some embodiments, the barn door 175 may both slide horizontally along the track and/or swing outwardly and inwardly relative to a pivot point relative to the track. The latch mechanism 100 may engage with and/or lock with the lock mechanism 105 regardless of the closing motion: sliding along the track or swinging relative to the track.

In some embodiments, the latch mechanism 100 includes an internal handle 110 and a latch head 115 coupled to the interior of the barn door 175. The latch mechanism 100 includes a pivot axis 117 about with the internal handle 110 and/or the latch head 115 rotate. In some embodiments, an external handle may be coupled with the pivot axis on the exterior of the barn door. When the external handle is rotated, the external handle may rotate an axle that extends through the barn door 175 through the pivot axis 117 and may rotate the internal handle 110 and/or the latch head 115. When the internal handle 110 and/or the latch head 115 is rotated, the internal handle 110 and/or the latch head 115 may rotate an axle that extends through the barn door 175 through the pivot axis 117 and may rotate the external handle.

The latch head 115 may have a portion that has a hook shape (or an inverted U shape). The hook shape may be shaped to include a gap that may be configured to engage with keeper 140 of the lock mechanism 105. For example, the hook shape may have a gap that is sized to be slightly larger than the diameter of the keeper 140.

A spring 118 may bias the latch mechanism 100, for example, such that the latch head 115 and the internal handle 110 are roughly horizontal and/or perpendicular to the doorjamb 180 in a steady state position. When the latch mechanism 100 is rotated away from the steady state position and released, the spring 118 may rotate the latch head 115 and the internal handle 110 into the steady state position. The spring 118 may include a torsion spring.

In some embodiments, the latch head 115 may include a front angled surface 125 at the tip, head, or end of the latch head 115. The front angled surface 125, for example, may be angled an angle θ from a vertical reference line when the latch head 115 is not rotated or in the zero-bias position as shown in FIG. 8B. The angle θ, for example, may be an angle from about 10° to 60°. The angle θ, as another example, may be an angle from about 30° to 50°.

In some embodiments, the latch head 115 may include a side angled surface 120. The side angled surface 120, for example, may be angled an angle φ from a vertical reference or from a flat surface of the latch head 115 when the latch head 115 is not rotated or in the zero-bias position as shown in FIG. 8C. The angle φ, for example, may be an angle from about 5° to 35°. The angle φ, as another example, may be an angle from about 15° to 30°.

In some embodiments, the latch mechanism 100 may comprise a metal such as, for example, steel, stainless steel, aluminum, or any alloy thereof, etc. In some embodiments, the latch mechanism 100 may comprise a plastic or composite material.

In some embodiments, the lock mechanism 105 may include a base plate 165. The base plate 165 may comprise a rectangular (or any other shape) shaped member that can be attached to the doorjamb 180. A keeper 140 may be coupled with the base plate 165. The keeper 140 may have a U-shape that extends from the base plate 165.

In some embodiments, the lock mechanism 105 may include a lock slider 130. The lock slider 130 may be moved horizontally relative to the base plate 165. The lock slider 130, for example, may be a plate shaped member with a knob 190 that extends from the rectangular portion of the lock slider 130.

The lock slider 130, for example, may include a first guide 145 cut as a channel within the lock slider 130. A first guide pin 155, for example, may be disposed at least partially within the first guide 145 and/or coupled with the base plate 165. The first guide pin 155, for example, may include a screw, bolt, or pin that may be coupled with the base plate 165. The first guide pin 155 may allow the lock slider 130 to slide along a path fixed by the length, shape, and/or direction of the first guide 145 relative to the base plate 165. The first guide 145 may include a channel that is substantially horizontal when the lock slider 130 is coupled with the base pate 165 via the first guide pin 155.

The lock slider 130, for example, may include a second guide 150 cut as a channel within the lock slider 130. A second guide pin 160, for example, may be disposed at least partially within the second guide 150 and/or coupled with the base plate 165. The second guide pin 160, for example, may include a screw, bolt, or pin that may be coupled with the base plate 165. The second guide pin 160 may allow the lock slider 130 to slide along a path fixed by the length, shape, and/or direction of the second guide 150 relative to the base plate 165. The second guide 150 may include a channel that is substantially horizontal when the lock slider 130 is coupled with the base pate 165 via the second guide pin 160.

In some embodiments, the lock slider 130 may be moved horizontally relative to the first guide pin 155 and/or the second guide pin 160. In some embodiments, the movement and/or the path of the lock slider 130 may be controlled as the first guide pin 155 slides within the first guide 145 and/or as the second guide pin 160 within the second guide 150.

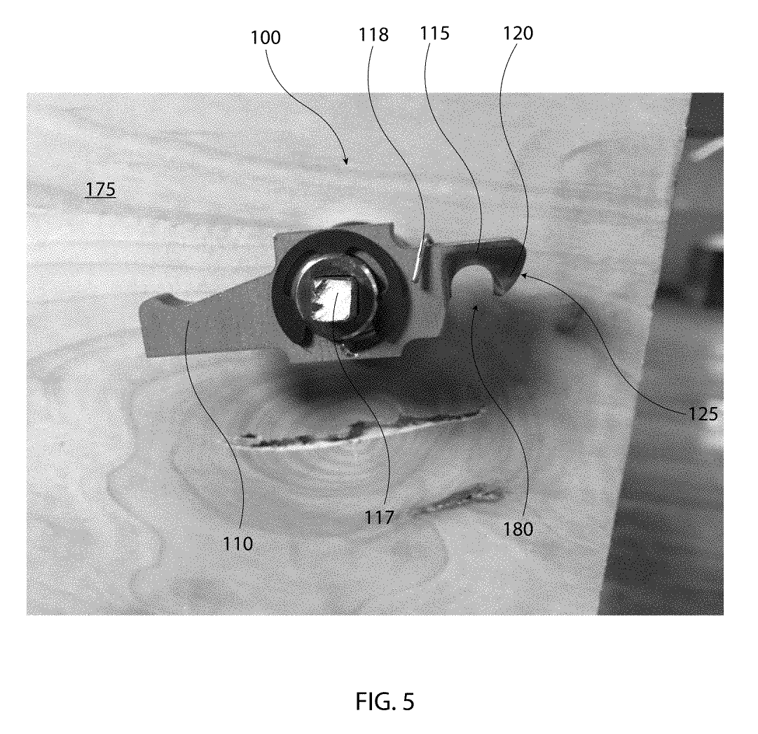

FIG. 5 illustrates a latch mechanism 100 in an unlocked configuration according to some embodiments. The latch mechanism 100 is disengaged from the keeper 140.

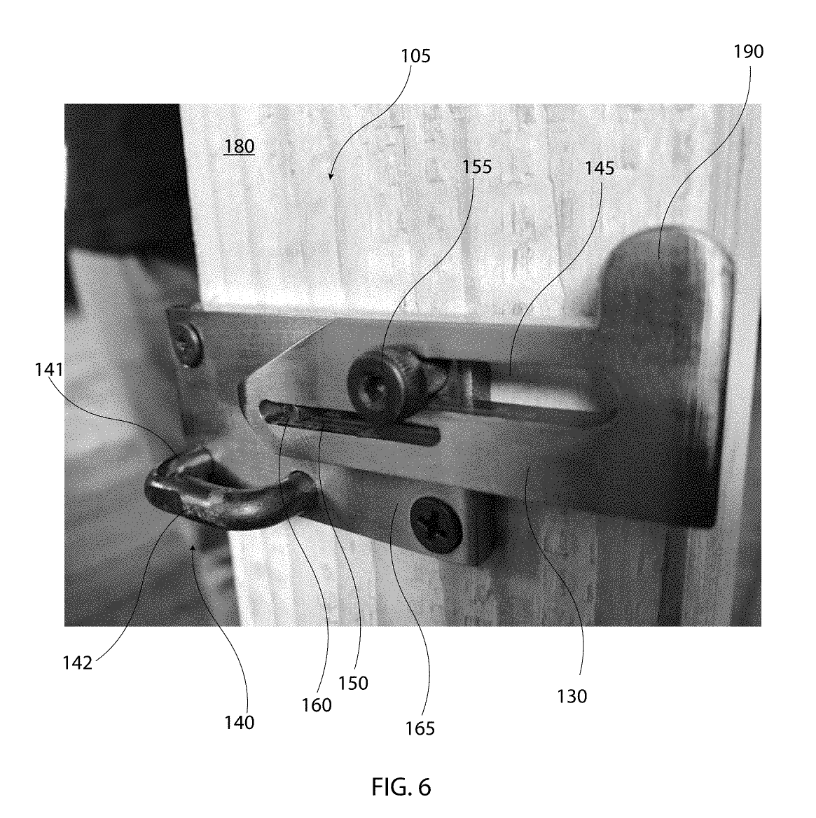

In some embodiments, the keeper 140 may be disposed on a forward portion of the base plate 165 as shown in FIG. 6. The lock slider 130, for example, may be positioned on a rearward portion of the base plate in the unlocked configuration and may be positioned on a frontward portion of the base plate in the locked configuration. In some embodiments, the forward portion of the base plate 165 may be positioned on the doorjamb 180 nearer the barn door 170 than the rearward portion of the base plate 165. The lock slider 130 may slide between the rearward portion and the frontward portion of the base plate 165.

In some embodiments, when the barn door 175 slides close to the doorjamb 180 (e.g., by sliding horizontally along a track coupled with a portion of the barn door 175), the latch mechanism 100 may engage with the lock mechanism. For example, the latch head 115 may engage with the keeper 140. For example, as the barn door 175 slides horizontally relative to the doorjamb 180, the front angled surface 125 may make contact with the middle portion of the keeper 142 causing the latch mechanism 100 to rotate upward about the pivot axis 117. As the latch head 115 continues to move horizontally after being rotated about the pivot axis 117, the void in the latch head 115 may be positioned relative to the keeper 140. The spring 118, for example, may rotate the latch head 115 downward causing the latch head 115 to engage with the keeper 140, which may also stop the barn door's momentum as it slides across the track.

In some embodiments, when the barn door 175 swings close to the doorjamb 180 (e.g., by swinging relative to a track coupled with the top of the barn door), the latch mechanism 100 may engage with the lock mechanism. For example, the latch head 115 may engage with the keeper 140. For example, as the barn door 175 swings relative to the doorjamb 180, the front angled surface 125 may make contact with the front portion of the keeper 141 causing the latch mechanism 100 to rotate upward about the pivot axis 117. As the latch head 115 continues to move toward the keeper 140 after being rotated about the pivot axis 117, the void in the latch head 115 may be positioned relative to the keeper 140. The spring 118, for example, may rotate the latch head 115 downward causing the latch head 115 to engage with the keeper 140, which may also stop the barn door's momentum as it slides across the track.

In some embodiments, a user may slide the lock slider 130 horizontally so that a portion of the lock slider 130 is positioned above the latch head 115 (e.g., sliding the lock slider 130 from a rearward position to a forward position). This position of the lock slider 130 above the latch head 115 may restrict the rotation of the latch mechanism 100 forcing the latch head 115 to remain engaged with the keeper regardless of a user trying to rotate the latch mechanism effectively locking the latch mechanism 100 and/or the latch head 115 with the keeper 140. The latch mechanism 100 may be unlocked by sliding the lock slider 130 horizontally away from the latch mechanism 100 (e.g., sliding the lock slider 130 from a forward position to a rearward position).

In some embodiments, the barn door 175 may include a hole positioned above the latch head. The hole may be positioned to allow a user to slide a pin, screwdriver, or the like through the hole in the barn door 175 and force the lock slider 130 to slide horizontally from the locked position to the unlocked position (e.g., from a forward position to a rearward position). The hole, for example, may be useful to unlock the latch mechanism 100 from the lock mechanism 105 from the exterior of the barn door 175.

Some embodiments may include a locking mechanism that may include a pin that extends or retracts whether the locking mechanism is in a locked or an unlocked position. The pin may be engaged with a pin locking mechanism that includes a slide mechanism. The door may be unlocked form the outside by retracting the pin and/or unlocked from the inside by disengaging a sliding mechanism.

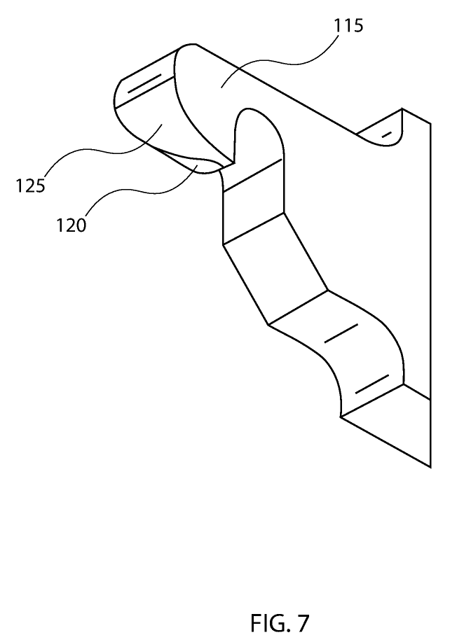

FIG. 7 is a drawing of a latch head 115 according to some embodiments. The latch head 115 includes a side angled surface 120 and/or a front angled surface 125.

FIG. 8A is a top view of the internal handle 110 and the latch head 115 of a latch mechanism 100 according to some embodiments. FIG. 8B is a side view of the internal handle 110 and the latch head 115 of a latch mechanism 100 according to some embodiments. FIG. 8C is a front view of the internal handle 110 and the latch head 115 of a latch mechanism 100 according to some embodiments.

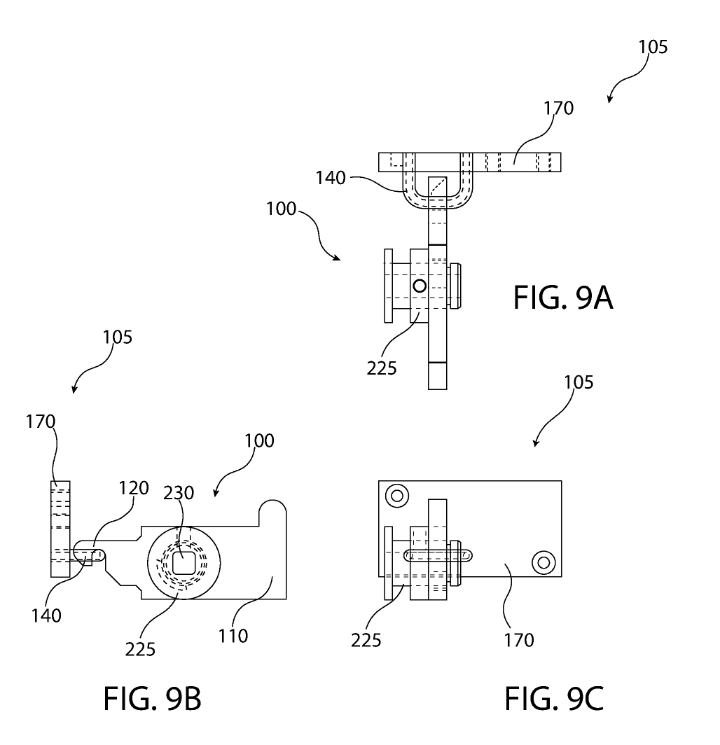

FIG. 9A is a top view of the internal handle 110 and the latch head of a latch mechanism 100 engaged with a keeper 140 according to some embodiments. FIG. 9B is a side view of the internal handle 110 and the latch head 115 of a latch mechanism 100 engaged with a keeper 140 according to some embodiments. FIG. 9C is a front view of the internal handle 110 and the latch head 115 of a latch mechanism 100 engaged with a keeper 140 according to some embodiments.

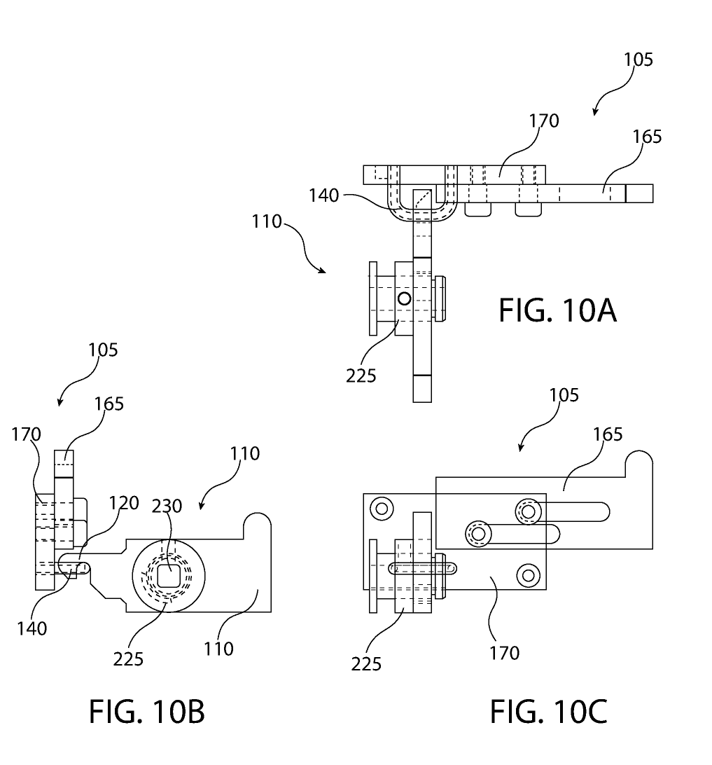

FIG. 10A is a top view of a latch mechanism 100 engaged with a keeper 140 and a lock slider 130 in the unlocked configuration. FIG. 10B is a side view of a latch mechanism 100 engaged with a keeper 140 and the lock slider 130 in the unlocked configuration. FIG. 10C is an end view of a latch mechanism 100 engaged with a keeper 140 and the lock slider 130 in the unlocked configuration.

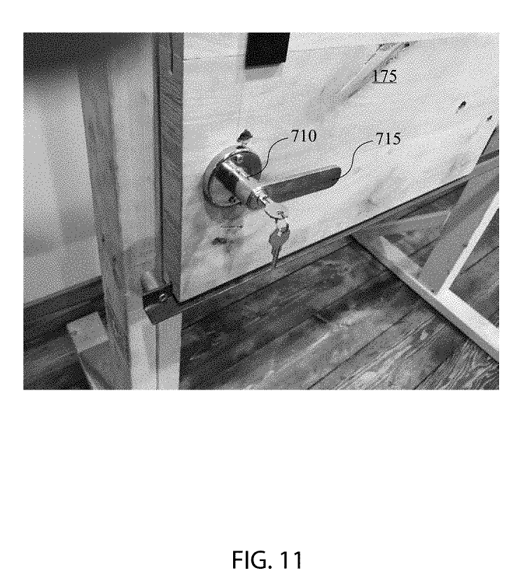

FIG. 11 illustrates a locking mechanism 710 with an external handle 715 according to some embodiments. The locking mechanism 710 is coupled with a barn door 175.

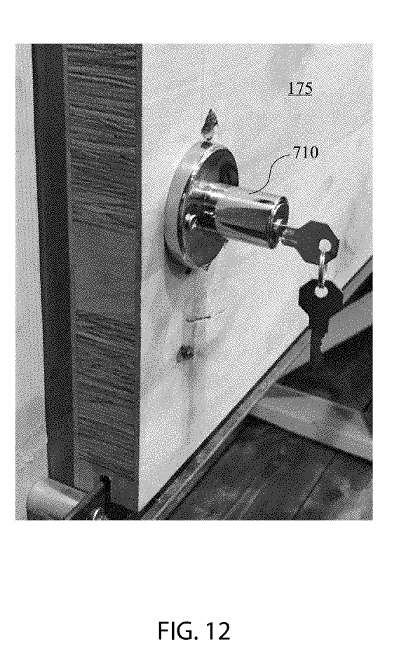

FIG. 12 illustrates a locking mechanism 710 without an external handle according to some embodiments. The locking mechanism 710 may have any shape or configuration.

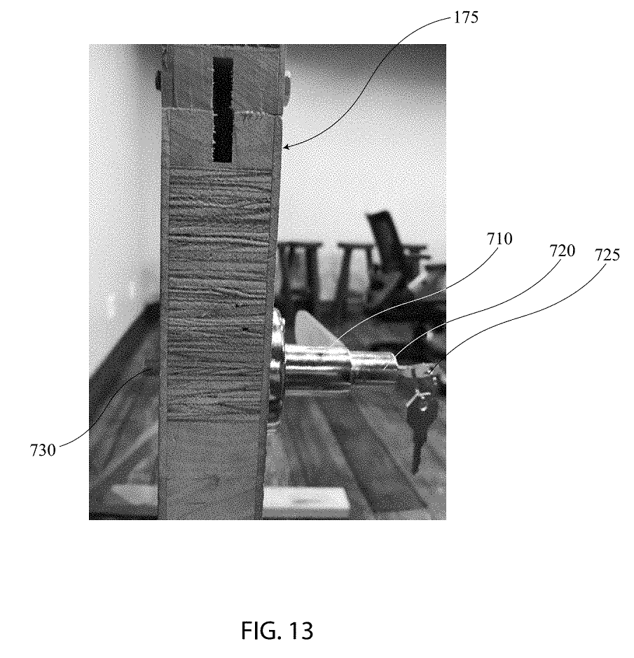

FIG. 13 illustrates a locking mechanism 710 in an unlocked position according to some embodiments. The locking mechanism 710 is coupled with a locking pin 730 that extends through the barn door 175. When in the unlocked position, the locking pin 730 is not extended, and key lock chamber 720 is extended. In some embodiments, the key 725 can be turned (and/or engaged) to change the locking mechanism 710 from a locked configuration to the unlocked configuration shown in FIG. 9. For example, when the key lock chamber 720 is unlocked the, the key lock chamber 720 may extend via spring action.

The key lock chamber 720, for example, can slide into the locking mechanism 710 when in the locked position causing the locking pin 730 to extend (e.g., FIG. 10) through the barn door 175. The key lock chamber 720, for example, can slide out of the locking mechanism 710, for example, via spring action, when in the unlocked position causing the locking pin 730 to retract (e.g., FIG. 9) into the barn door 175.

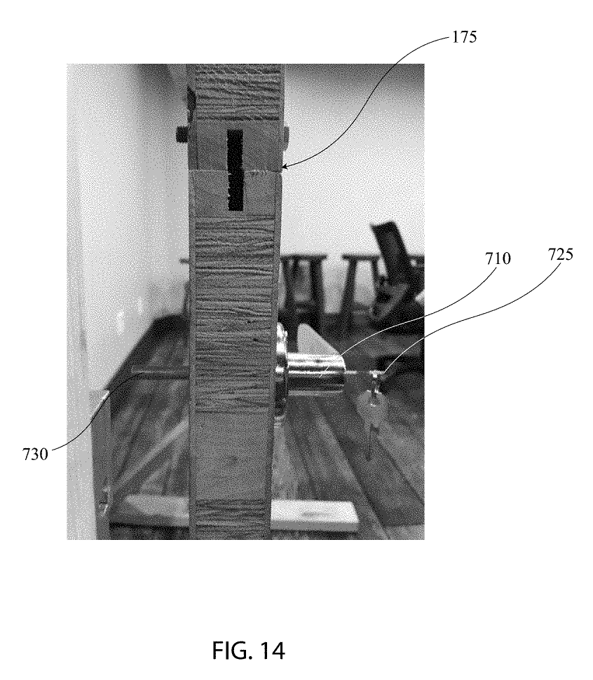

FIG. 14 illustrates a locking mechanism 710 in the locked position according to some embodiments. In the locked position, the locking pin 730 is extended as shown in FIG. 10. The locking pin 730 may extend ½″, ¾″, 1″, 1¼″, 1½″, 1¾″, 2″, etc.

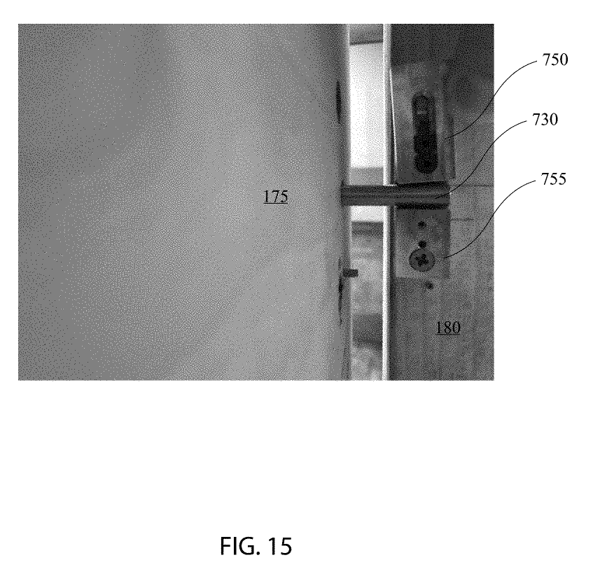

FIG. 15 illustrates a pin locking mechanism 755 according to some embodiments. The pin locking mechanism 755 includes a slide mechanism 750. The pin locking mechanism 755 may also include a pin receptacle (or groove) within which the locking pin 730 may be engaged when the locking mechanism is in the locked position. In this example, the slide mechanism 750 may be disengaged, which may allow the barn door 175 to slide even though the locking mechanism is in the locked position and/or the pin locking mechanism 755 is extended. The pin locking mechanism 755 may be attached or coupled with a doorjamb 180.

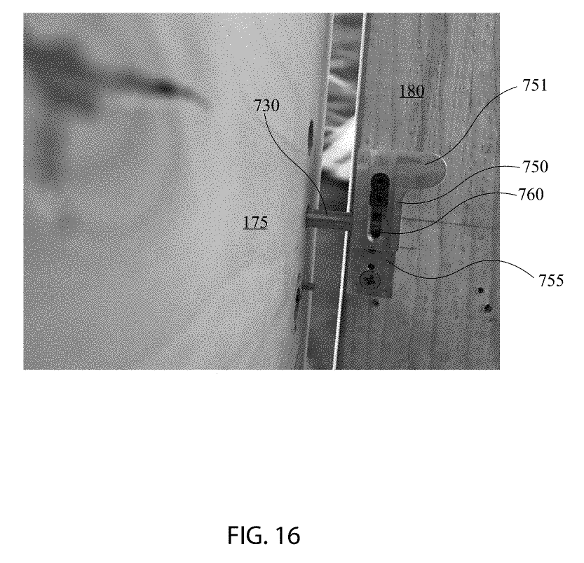

FIG. 16 illustrates a pin locking mechanism 755 engaged with a locking pin 730 according to some embodiments. The slide mechanism 750 is engaged with the locking pin 730. In this example, the pin locking mechanism 755 is engaged with the locking pin 730 in the locked position such that the barn door 175 cannot slide. The slide mechanism 750, for example, may slide vertically between the engaged position (FIG. 12) and the disengaged position (FIG. 11).

In some embodiments, the slide mechanism 705 may slide horizontally or rotate about a pivot point between an engaged position and a disengaged position.

The slide mechanism 750 may include a detent 751 that may be used to slide the slide mechanism 750 between engaged and disengaged positions.

The slide mechanism 750 may include an inner channel 760. The slide mechanism 750 may be coupled with the pin locking mechanism 755 with one or more bolts that may allow the slide mechanism 750 to slide relative to the pin locking mechanism 755 and/or the doorjamb 180.

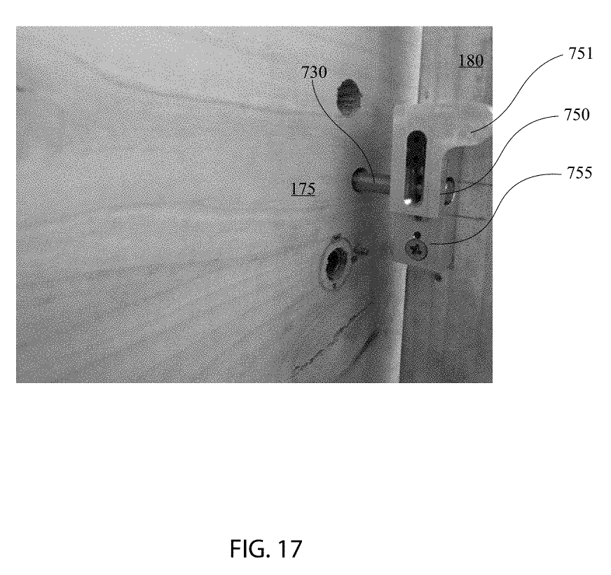

FIG. 17 illustrates a pin locking mechanism 755 engaged with a locking pin 730 according to some embodiments.

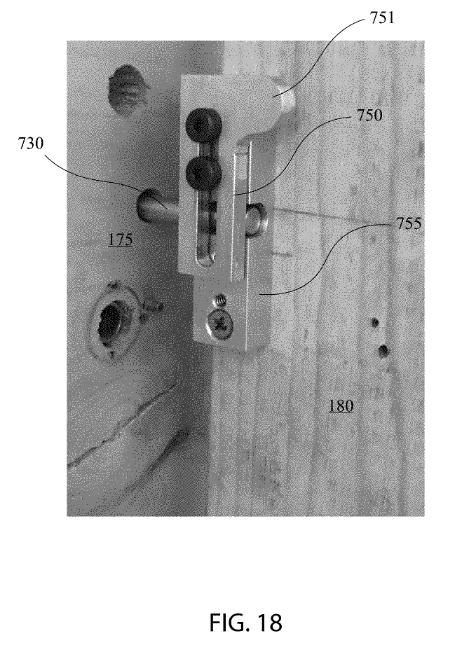

FIG. 18 illustrates a pin locking mechanism 755 engaged with a locking pin 730 according to some embodiments.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the present disclosure has been presented for purposes of example rather than limitation, and does not preclude inclusion of such modifications, variations and/or additions to the present subject matter as would be plain to one of ordinary skill in the art.

That which is claimed:

1. A locking mechanism for a barn door comprising:
a locking mechanism body;
a lock chamber configured to slide into the locking mechanism body in a locked configuration, and configured to slide out of the locking mechanism body in a first direction in an unlocked configuration; and
a locking pin coupled with the lock chamber, the locking pin configured to slide outward in a second direction opposite the first direction in the locked configuration, and configured to slide inward in the unlocked configuration.

2. The locking mechanism according to claim 1, wherein the locking mechanism body comprises a cylindrical portion with a hollow center and the lock chamber has a cylindrical shape that slides into and out of the hollow center.

3. The locking mechanism according to claim 1, wherein the lock chamber comprises a key lock.

4. The locking mechanism according to claim 1, wherein the locking mechanism body comprises a base configured to couple with a barn door.

5. The locking mechanism according to claim 1, further comprising a pin locking mechanism having a pin channel, the pin locking mechanism configured to couple with a door frame.

6. The locking mechanism according to claim 5, wherein the pin channel is sized and configured to receive the locking pin.

7. The locking mechanism according to claim 5, wherein the pin locking mechanism comprises a slide mechanism configured to slide vertically.

8. The locking mechanism according to claim 7, wherein the slide mechanism covers the pin channel when the slide mechanism is in a first position and the slide mechanism uncovers the pin channel when the slide mechanism is in a second position.

9. The locking mechanism according to claim 8, wherein the pin locking mechanism restricts motion of a barn door coupled with the locking mechanism body when the locking pin is disposed within the pin channel and the slide mechanism is in the first position.

10. The locking mechanism according to claim 1, further comprising a spring configured to actuate the lock chamber from the locked position to the unlocked position.
